(19) United States
(12) Patent Application Publication
(10) Pub. No.: US 2025/0372902 A1
(43) Pub. Date: Dec. 4, 2025

(54) ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: James M. SABO, Marysville, PA (US)

(21) Appl. No.: 19/222,152

(22) Filed: May 29, 2025

Related U.S. Application Data
(60) Provisional application No. 63/654,183, filed on May 31, 2024.

(51) Int. Cl. H01R 12/75; H01R 12/70; H01R 12/71; H01R 13/24; H01R 13/627

(52) U.S. Cl. CPC H01R 12/75; H01R 12/7082; H01R 12/716; H01R 13/24; H01R 13/6273

(57) ABSTRACT

An electrical connector assembly includes: a plug connector including a plug housing, a terminal secured to the plug housing, and a cable connected to the terminal; and a mating receptacle connector including a receptacle housing and a contact secured to the receptacle housing, wherein the plug housing engages the receptacle housing, the terminal includes a pair of beams, the contact includes a U-shaped portion, a pair of bends extending from two side plates of the U-shaped portion away from each other, and a pair of connecting portions extending from the pair of bends for mounting to a printed circuit board, and the pair of beams of the terminal engage between the two side plates of the U-shaped portion of the contact.

### CROSS-REFERENCE TO RELATED APPLICATION

This application claims priority to U.S. Provisional Application Ser. No. 63/654,183, filed on May 31, 2024, which is incorporated herein by reference in its entirety.

### BACKGROUND OF THE INVENTION

### Field of the Invention

The present invention relates to an electrical connector assembly for mounting to a printed circuit board, comprising: a plug connector including a plug housing, a terminal secured to the plug housing, and a cable connected to the terminal; and a mating receptacle connector including a receptacle housing and a contact secured to the receptacle housing, wherein the plug housing engages the receptacle housing and the terminal and the contact are designed to engage each other for establishing desired paths for current to flow.

### Description of Related Arts

U.S. Pat. No. 10,069,223 discloses an electrical cable connector comprising a first front terminal attached to a first upper cable and a second rear terminal attached to a second lower cable. Each of the front and rear terminals has a plurality of contact tails extending downward to be mounted to a printed circuit board.

U.S. Patent Application Publication No. 2022/0336987 discloses an electrical connection assembly comprising a first upper electrical connection terminal connected to a cable, a second lower electrical connection terminal connected to a bus bar, and a mating terminal therebetween with a first mating end matched with the first upper electrical connection terminal and a second mating end second lower electrical connection terminal.

### SUMMARY OF THE INVENTION

An electrical connector assembly for mounting to a printed circuit board comprises: a plug connector including a plug housing, a terminal secured to the plug housing, and a cable connected to the terminal; and a mating receptacle connector including a receptacle housing and a contact secured to the receptacle housing, wherein: the plug housing engages the receptacle housing; the terminal includes a pair of beams; the contact includes a U-shaped portion, a pair of bends extending from two side plates of the U-shaped portion away from each other, and a pair of connecting portions extending from the pair of bends for mounting to a printed circuit board; and the pair of beams of the terminal engage between the two side plates of the U-shaped portion of the contact.

### BRIEF DESCRIPTION OF DRAWINGS

FIG. 1 is a perspective view of an electrical connector assembly in accordance with the present invention mounted to a printed circuit board (PCB);

FIG. 2 is an exploded view of the electrical connector assembly;

FIG. 3 is a view similar to FIG. 2 but from another perspective;

FIG. 4 is a cross-sectional view of the electrical connector assembly in FIG. 1;

FIG. 5 is another cross-sectional view of the electrical connector assembly in FIG. 1;

FIG. 6 is an exploded view of a receptacle connector of the electrical connector assembly;

FIG. 7 is a view similar to FIG. 6 but from another perspective;

FIG. 8 is an exploded view of a plug connector of the electrical connector assembly;

FIG. 9 is a view similar to FIG. 8 but from another perspective;

FIG. 10 is a perspective view of upper and lower cables connected to front and rear terminals, respectively, of the plug connector;

FIG. 11 is another exploded view of the plug connector; and

FIG. 12 is another exploded view of the electrical connector assembly.

### DETAILED DESCRIPTION OF THE DRAWINGS

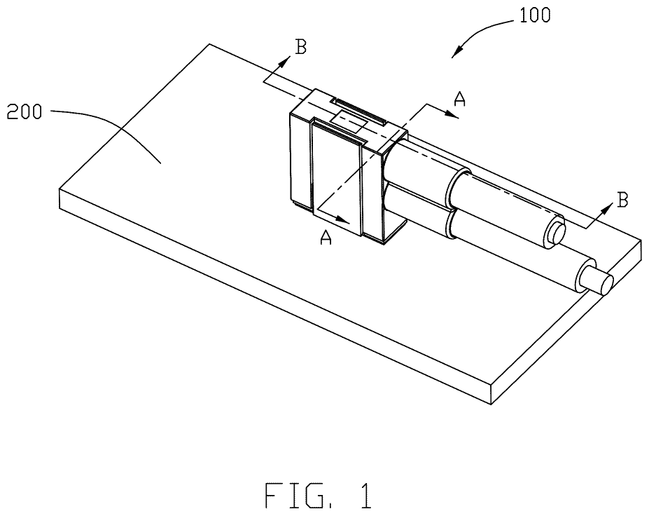

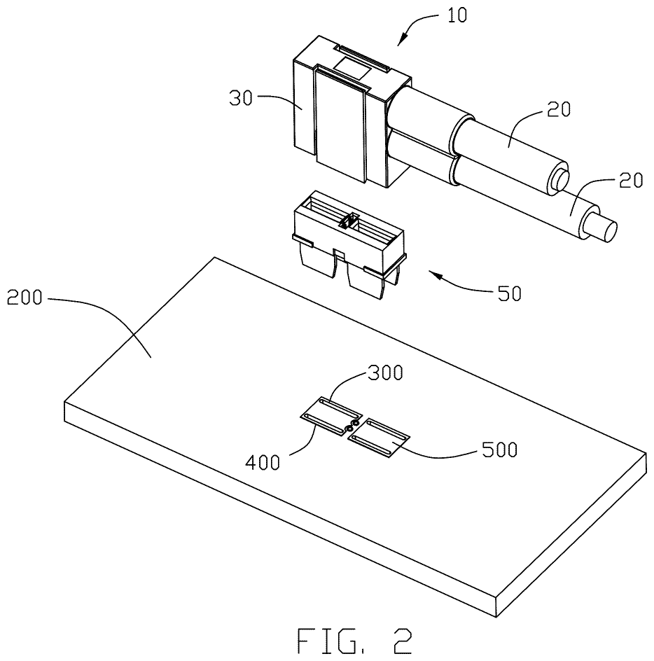

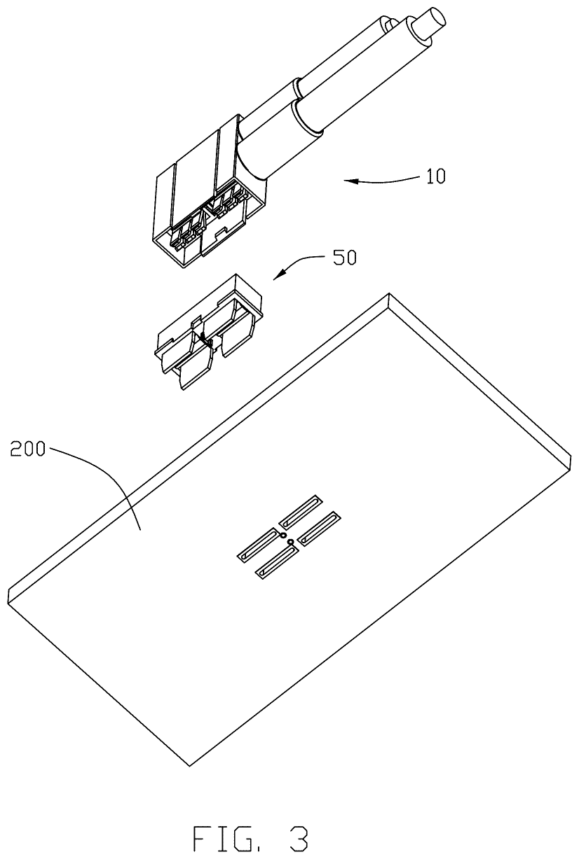

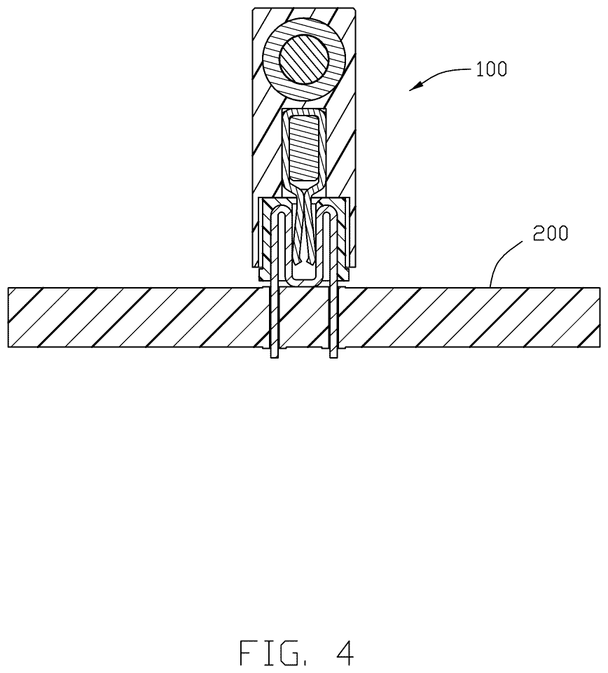

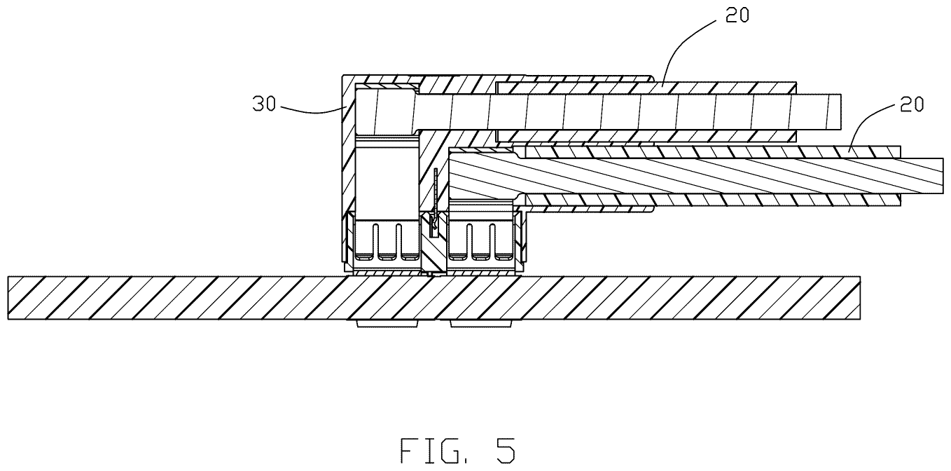

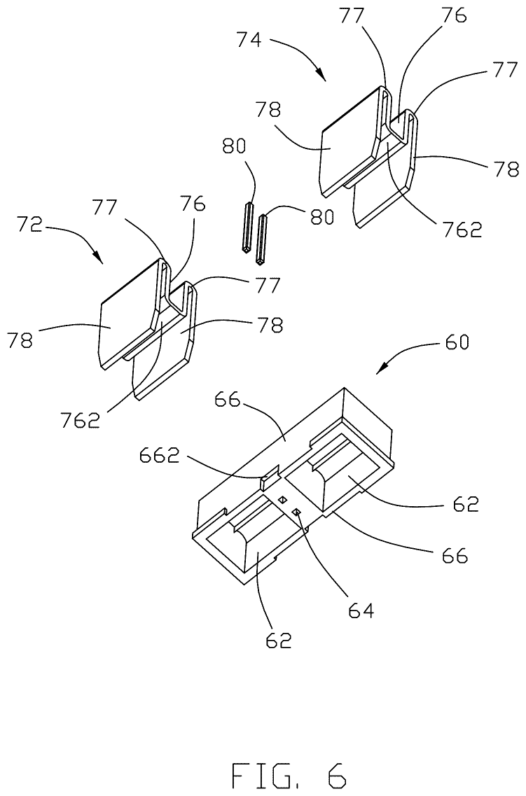

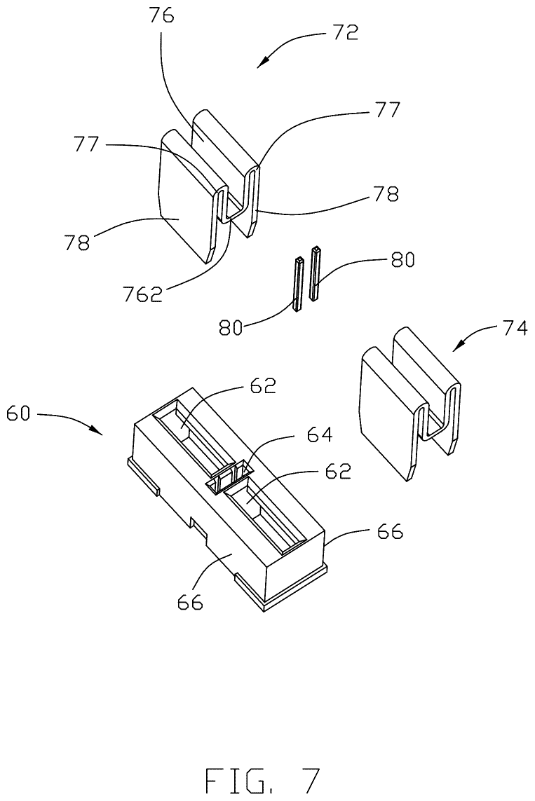

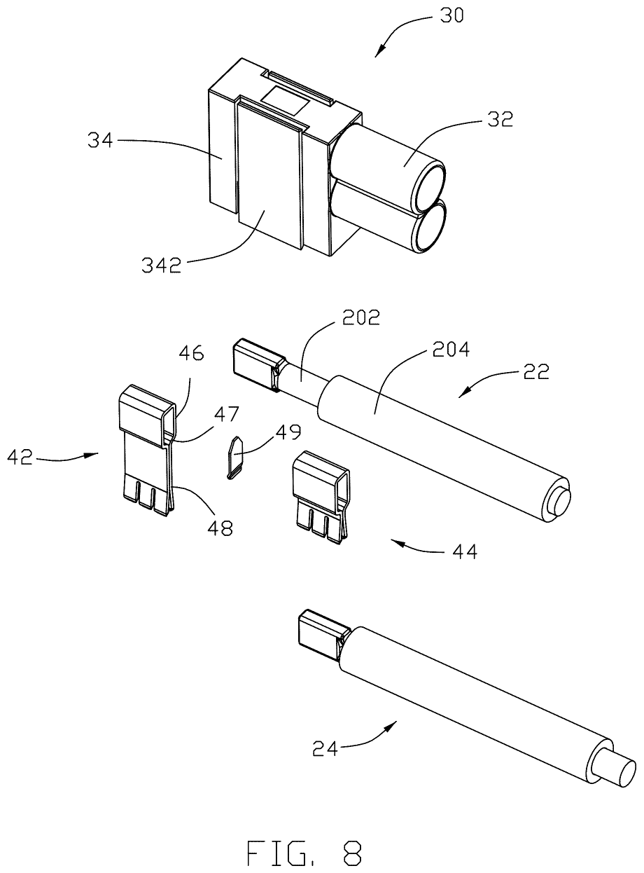

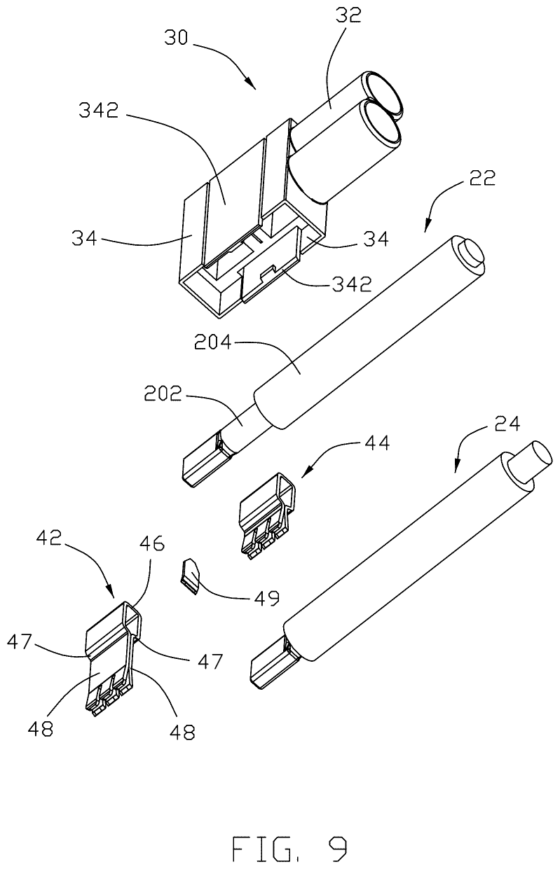

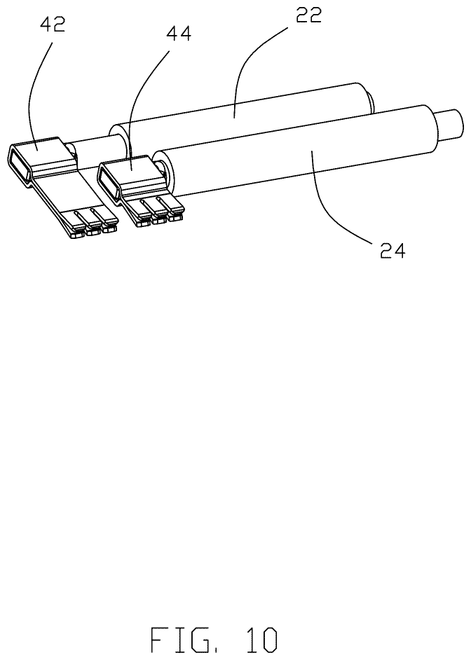

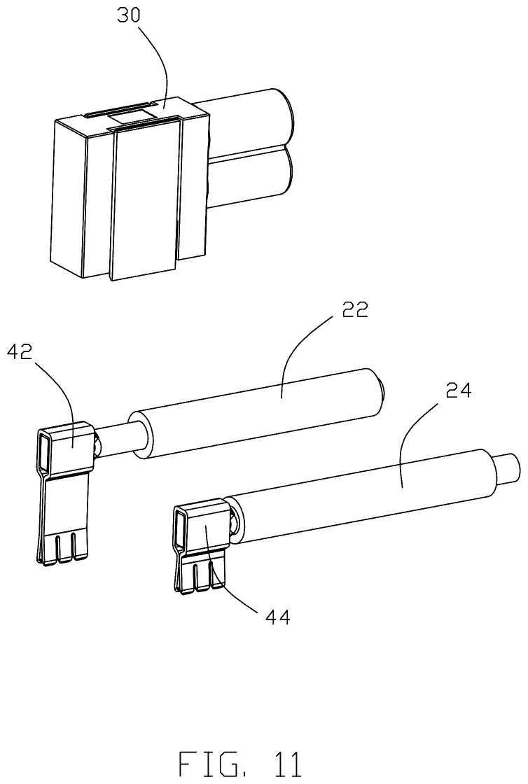

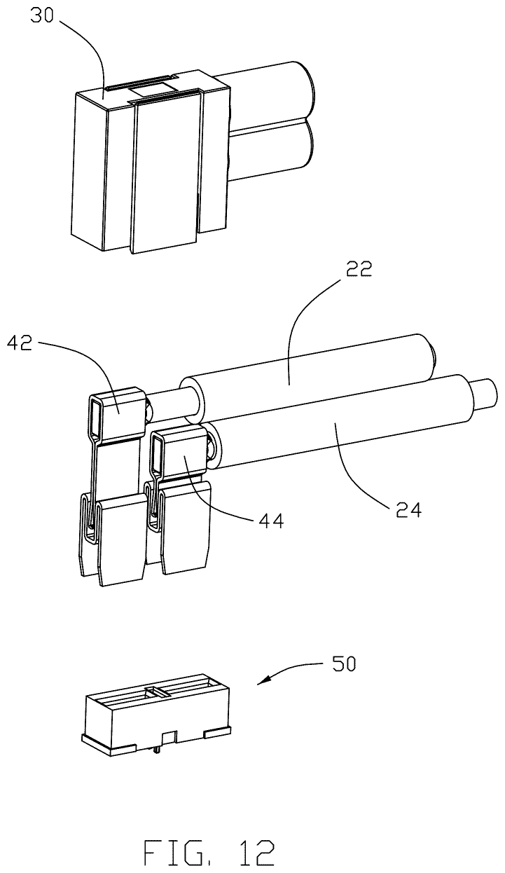

Referring to FIGS. 1-12, an electrical connector assembly 100 comprises a plug connector 10 and a mating receptacle connector 50. The plug connector 10 includes cables 20; the receptacle connector 50 is mounted to a PCB 200. The plug connector 10 includes a plug housing 30 and a front terminal 42 and a rear terminal 44 both secured to the plug housing 30. The front terminal 42 is connected to an upper cable 22 and the rear terminal 44 is connected to a lower cable 24. Each cable 20 may include a conductor 202 and an insulator 204. As is known in this art, the conductor 202 can include wire strands that may be braided, twisted, or otherwise intertwined as desired and can be pre-formed in preparation for being ultrasonically bonded, welded, or soldered to the front terminal 42 or the rear terminal 44. Specifically, as shown in FIGS. 8-12, the conductor 202 of the cable 20 may have a pre-formed area exposed from the insulator 204 and shaped so as to define a solidified shape corresponding in shape to an inner surface of the front terminal 42 or the rear terminal 44.

The plug housing 30 may include a sleeve 32 for receiving the upper cable 22 and the lower cable 24 and a pair of side walls 34 each having a respective side latch 342. Each of the front terminal 42 and the rear terminal 44 includes a U-shaped portion 46, a pair of bends 47 extending from two side plates of the U-shaped portion 46 toward each other, and a pair of beams 48 extending from the pair of bends 47. The two side plates of the U-shaped portion 46 are secured to an interior wall surface of the housing 30, preferably by way of an interference fit. Each of the two side plates of the U-shaped portion 46 may be substantially planar. Each of the pair of beams 48 may be in the form of a flexible spring arm, e.g., with three spring fingers. The pre-formed area of the conductor 202 of the cable 20 may be clamped between the two side plates of the U-shaped portion 46. The plug connector 10 may further include a communing blade 49 secured to the housing 30.

The receptacle connector 50 includes a receptacle housing 60 and a front contact 72 and a rear contact 74 both secured to the receptacle housing 60. Specifically, the front contact 72 and the rear contact 74 are mounted in a pair of holes 62 of the receptacle housing 60. The receptacle housing 60 may include a pair of side walls 66 each having a respective step 662 to be latched by a corresponding step side latch 342 of the plug housing 30. Each of the front contact 72 and the rear contact 74 includes a U-shaped portion 76, a pair of bends 77 extending from two side plates of the U-shaped portion 76 away from each other, and a pair of connecting portions 78 extending from the pair of bends 77 for mounting to the PCB 200. Each of the pair of connecting portions 78 may be substantially planar. The pair of connecting portions 78 may be secured to an interior wall surface of the housing 60, preferably by way of interference fit. The pair of beams 48 of the terminal 42 or 44 engage between the two side plates of the U-shaped portion 76 of the contact 72 or 74 and may bear against each other. The U-shaped portion 76 has a base 762 for surface mounting to the PCB 200. The receptacle connector 50 may further include a pair of separate posts 80 secured to the receptacle housing 60. Correspondingly, the PCB 200 may have vias 300 for receiving the pair of separate posts 80. Specifically, the pair of separate posts 80 are exposed to a slot 64 of the receptacle housing 60 between the pair of holes 62 for engaging the communing blade 49 of the plug connector 10 so that when the plug connector 10 and the receptacle connector 50 are mated the communing blade 49 bridges the two posts 80 to complete a circuit through the PCB 200 and send a signal indicating a full mating. The PCB 200 may further have vias or holes 400 for receiving the connecting portions 78 of the front contact 72 and the rear contact 74 and conductive pads 500 for contacting the bases 762 of the front and rear contacts 72 and 74.

1. An electrical connector assembly for mounting to a printed circuit board, comprising:
a plug connector including:
a plug housing;
a terminal secured to the plug housing; and
a cable connected to the terminal; and
a mating receptacle connector including:
a receptacle housing; and
a contact secured to the receptacle housing; wherein
the plug housing engages the receptacle housing;
the terminal includes a pair of beams;
the contact includes a U-shaped portion, a pair of bends extending from two side plates of the U-shaped portion away from each other, and a pair of connecting portions extending from the pair of bends for mounting to a printed circuit board; and
the pair of beams of the terminal engage between the two side plates of the U-shaped portion of the contact.

2. The electrical connector assembly as claimed in claim 1, wherein the terminal includes a U-shaped portion and a pair of bends extending from two side plates of the U-shaped portion toward each other, and the pair of beams extend from the pair of bends.

3. The electrical connector assembly as claimed in claim 1, wherein the pair of beams of the terminal bear against each other.

4. The electrical connector assembly as claimed in claim 1, wherein the U-shaped portion of the contact has a base for surface mounting to the printed circuit board.

5. The electrical connector assembly as claimed in claim 1, wherein:
the plug connector includes a front terminal and a rear terminal both secured to the plug housing and an upper cable connected to the front terminal and a lower cable connected to the rear terminal;
the receptacle connector includes a front contact and a rear contact both secured to the receptacle housing; and
the front terminal engages the front contact and the rear terminal engages the rear contact.

6. The electrical connector assembly as claimed in claim 1, wherein the receptacle connector comprises a pair of separate posts secured to the receptacle housing and the plug connector comprises a communing blade secured to the plug housing for bridging the pair of separate posts together.

7. The electrical connector assembly as claimed in claim 1, wherein the plug housing includes a pair of side latches, and the receptacle housing includes a pair of side walls each having a respective step latched by a corresponding side latch.

8. A plug connector including:
a plug housing;
a terminal secured to the plug housing; and
a cable connected to the terminal;
wherein
the terminal includes a U-shaped portion welded with the cable, a pair of bends extending from two side plates of the U-shaped portion toward each other in a first direction, and a pair of beams extending from the bends in a second direction different from the first direction to mate with the contacts of the mating connector.

9. The plug connector as claimed in claim 8, wherein the pair of beams of the terminal bears against each other.

10. The plug connector as claimed in claim 8, wherein each of the pair of beams includes a plurality of flexible spring arms.

11. The plug connector as claimed in claim 8, wherein there are a front terminal and a rear terminal both secured to the plug housing and an upper cable connected to the front terminal and a lower cable connected to the rear terminal.

12. The plug connector as claimed in claim 11, wherein the front terminal is higher than the rear terminal.

13. The plug connector as claimed in claim 12, wherein a converging portion of the beam of the front terminal is higher than that of the rear terminal.

14. The plug connector as claimed in claim 11, wherein the plug housing includes a sleeve for receiving the upper cable and the lower cable.

15. The plug connector as claimed in claim 8, wherein each cable includes a conductor and an insulator and the conductor of the cable has a pre-formed area exposed from the insulator and shaped so as to define a solidified shape corresponding in shape to an inner surface of the U-shaped portion.

16. A receptacle connector for mounting to a printed circuit board, including:
a receptacle housing; and
a contact secured to the receptacle housing;
wherein
the contact includes a U-shaped portion, a pair of bends extending from two side plates of the U-shaped portion away from each other, and a pair of connecting portions extending from the pair of bends for mounting to the printed circuit board and secured to an interior wall surface of the receptacle housing.

17. The receptacle connector as claimed in claim 16, wherein the U-shaped portion has a base for surface mounting to the printed circuit board.

18. The receptacle connector as claimed in claim 16, wherein the receptacle connector includes a front contact and a rear contact both secured to the receptacle housing.
